(19) United States
(12) Patent Application Publication
(10) Pub. No.: US 2020/0116260 A1
(43) Pub. Date: Apr. 16, 2020

(54) SHAFT SEAL ASSEMBLY

(71) Applicant: Caterpillar Inc., Deerfield, IL (US)

(72) Inventor: Alexander Nikolic, Peoria, IL (US)

(73) Assignee: Caterpillar Inc., Deerfield, IL (US)

(21) Appl. No.: 16/156,898

(22) Filed: Oct. 10, 2018

(51) Int. Cl. F16J 15/3204

(52) U.S. Cl. CPC F16J 15/3204

(57) ABSTRACT

A shaft seal assembly for a rotating shaft assembly includes a shaft seal and a bore insert that encircles a shaft. The bore insert can fill a bore space disposed between an oil sealing assembly and a housing of the rotating shaft assembly. The shaft seal includes a shaft seal arm that can contact the bore insert and provide a seal.

### TECHNICAL FIELD

The present disclosure generally pertains to seals. More particularly this application is directed toward a shaft seal assembly.

### BACKGROUND

Transmissions, engines, pumps, and other machinery of the like contain rotating parts that require a lubrication section to maintain performance. Seals are used on these rotating parts to inhibit debris and contaminants from making an intrusion into the lubrication section. An intrusion of debris or contaminants into the lubrication section could increase wear and cause premature system failure.

U.S. Pat. No. 8,474,825 to Takehiro Nakagawa, describes a sealing device comprising an oil seal mounted to a non-rotating housing and a dust cover mounted to a rotating body outside the oil seal. One of the oil seal and the dust cover has an external seal lip slidably in close contact with the other of them outside the slide sections between the oil seal and the rotating body. The oil seal and the dust cover have non-contact lips which are positioned outside the slide sections and inside the external seal lip. The non-contact lips have substantially conical tubular shapes which become larger in diameter toward the tips thereof. A labyrinth seal is provided at the outer diameter side of the external seal lip.

The present disclosure is directed toward overcoming one or more of the problems discovered by the inventors.

### SUMMARY

A shaft seal assembly for use in a rotating shaft assembly is disclosed herein. The rotating shaft assembly includes a central axis, a shaft that rotates about the central axis and has a shaft outer surface, a housing, an oil sealing assembly, and a bore space between the housing and oil sealing assembly. The shaft seal assembly comprises a bore insert and a shaft seal. The bore insert is disposed outward from the shaft and in the bore space. The shaft seal encircles the shaft and is disposed inward of the bore insert. The shaft seal includes a shaft seal body that contacts the shaft outer surface and extends radially outward from the central axis, and a shaft seal arm that extends from the shaft seal body outward from the central axis; and contacts the bore insert.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is an isometric view of a portion of a rotating shaft assembly having a shaft seal assembly;

FIG. 2 is a front view of the portion of a rotating shaft assembly section of FIG. 1; and

FIG. 3 is a cross section of the portion of a rotating shaft assembly section taken along the line 3-3 of FIG. 2.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. Further, it is understood that references to rotating and non-rotating components are exemplary, and that such a reference includes components that move relative to one another, and thus non-rotating is not limited to only stationary components. However, it will be apparent that those skilled in the art will be able to understand the disclosure without these specific details.

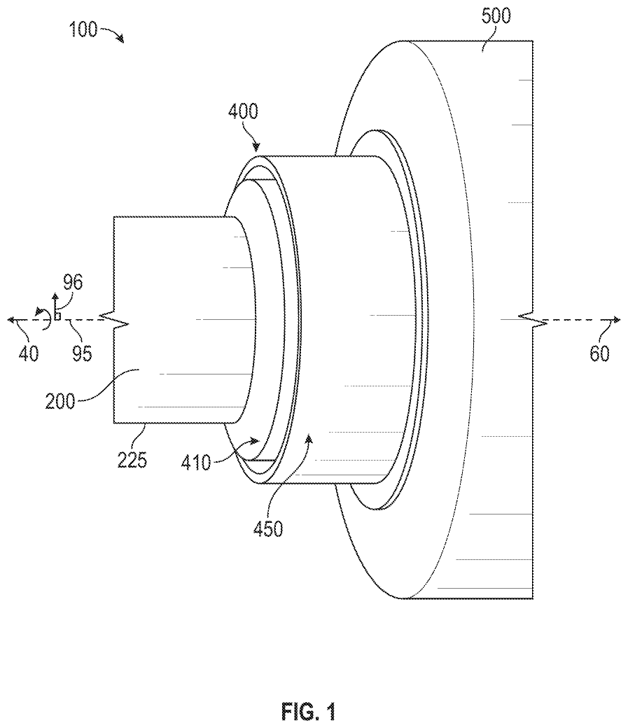

FIG. 1 is an isometric view of a portion of a rotating shaft assembly section. The disclosure may reference a forward direction 40 and an aft direction 60. Generally, references to the aft direction 60 are towards the power receiving end (not shown) of a shaft 200 (e.g., towards the engine) of a rotating shaft assembly 100. Generally, references to the forward direction 40 are away from the power receiving end of the shaft 200. Furthermore, the disclosure may generally reference a central axis 95 of rotation of a rotating shaft assembly 100, which may be generally defined by the longitudinal axis of its shaft 200. All references to radial, axial, and circumferential directions and measures refer to central axis 95, unless specified otherwise, and terms such as “inner” and “outer” generally indicate a lesser or greater radial distance from the central axis 95. A radial may be in any direction perpendicular and radiating outward from central axis 95, such as radial 96.

The rotating shaft assembly 100 includes the shaft 200, and a housing 500. The rotating shaft assembly 100 can also include a shaft seal assembly 400. The shaft 200 includes a shaft outer surface 225. The shaft 200 can rotate about the central axis 95 and may have a circular cross-section and be shaped as a cylinder. The shaft seal assembly 400 includes a shaft seal 410 and a bore insert 450. The housing 500 can be in contact with the bore insert 450 and disposed radially outward from the shaft 200 and the shaft seal assembly 400.

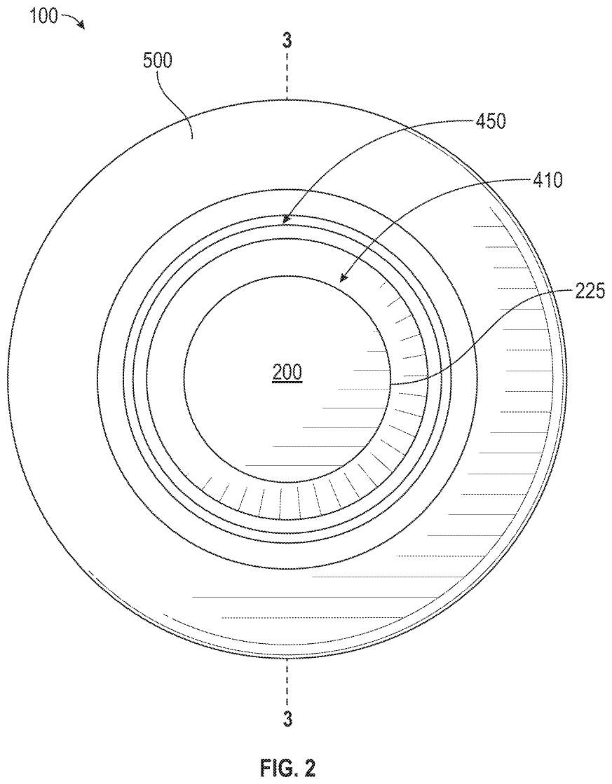

FIG. 2 is a front view of the portion of a shaft assembly section of FIG. 1. The shaft seal 410 encircles the shaft 200. In an embodiment the bore insert 450 encircles the shaft seal 410 and the housing 500 is disposed radially outward from the bore insert 450.

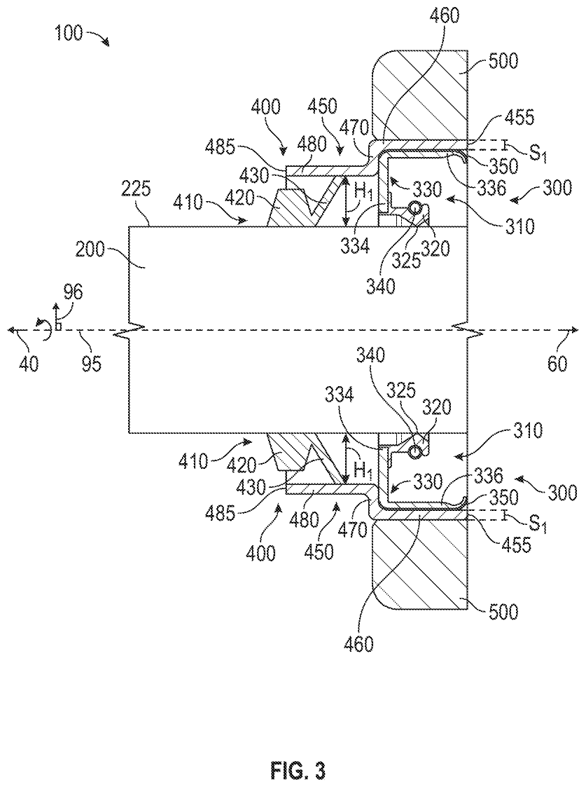

FIG. 3 is a cross-section view of the portion of a shaft assembly section of FIG. 2 taken along line 3-3. The rotating shaft assembly 100 further includes an oil sealing assembly 300 and a bore space S1 (shown occupied by a portion of the bore insert 450). In an embodiment the oil sealing assembly 300 may further include an oil cavity 310, an oil sealing element 320 having a shaft sealing edge 325, a radial lip seal 330, an oil sealing element ring 340, and a bore seal 350. The oil sealing element 320 encircles the shaft 200. The oil sealing element 320 can be disposed radially outward from the shaft 200. The oil sealing element 320 may include a shaft sealing edge 325 disposed proximal to the shaft outer surface 225. The shaft sealing edge 325 may contact the shaft outer surface 225, and be operable to provide a seal that prevents oil from leaking out of the oil sealing assembly 300. The oil sealing element ring 340 may provide a force directed radially inward on the oil sealing element 320 to help provide adequate contact between the shaft sealing edge 325 and the shaft outer surface 225. The oil sealing element ring 340 may be a garter spring. The radial lip seal 330 may include a radial lip seal body 334 and a radial lip seal arm 336. The radial lip seal body 334 may adjoin and generally extend radially outward from the oil sealing element 320. The radial lip seal arm 336 may extend axially from the radial lip seal body 334 towards the aft direction 60.

The bore seal 350 is disposed between the radial lip seal arm 336 and the housing 500 and adjoins the radial lip seal arm 336. The oil cavity 310 may be defined by the space created between the shaft outer surface 225, the oil sealing element 320, and the radial lip seal 330.

The bore space S1 is the space between the housing 500 and the oil sealing assembly 300. The bore space S1 can also be the space between the housing and the bore seal 350. The bore space S1 can vary in size depending on the sizing of the housing 500, oil sealing assembly 300, and bore seal 350.

The shaft seal 410 encircles the shaft outer surface 225. In an embodiment the shaft seal 410 may be a V-ring. The shaft seal 410 can be disposed more towards the forward direction 40 than the oil sealing assembly 300. The shaft seal 410 may be made of fluoroelastomers, nitrile rubber elastomers, synthetic resin material, elastomeric material or materials of the like. The shaft seal can be made to be resilient against wear and corrosion.

The shaft seal 410 includes a shaft seal body 420 and shaft seal arm 430. The shaft seal body 420 can be in contact with the shaft outer surface 225. The shaft seal body 420 is sized to be deployed about the shaft 200. The shaft seal body 420 may have a cross-section shaped as a trapezoid that is wider adjacent the shaft outer surface 225 than distal from the shaft outer surface 225. Alternatively, the shaft seal body 420 can have a cross-section shaped as a triangle. The shaft seal body 420 may extend radially outward from the shaft outer surface 225 and be adjacent the inner bore insert leg 480. The shaft seal body 420 may be disposed close enough to the bore insert 450 such that the space between is small enough to help prevent debris and contaminants from reaching the oil sealing assembly 300.

The shaft seal arm 430 extends outward from the from the shaft seal body 420. The shaft seal arm 430 may extend from the bottom of the shaft seal body 420 like a cantilever and extend radially outwards from the central axis 95 and extend towards the aft direction 60. Alternatively, the shaft seal arm 430 can extend from the shaft seal body 420 distal the shaft outer surface 225 or from another location on the shaft seal body. In one embodiment the shaft seal arm 430 can extend radially outward to a shaft seal arm height H1. Shaft seal height H1 is the radial distance between the shaft outer surface 225 and the top of the shaft seal arm 430. The shaft seal arm 430 may extend more radially outward from the central axis 95 than the shaft seal body 420. The shaft seal arm 430 may be in contact with an inner bore insert leg 480 at a sealing surface 440. Alternatively the shaft seal arm 430 and shaft seal body 420 may radially extend similar amounts such that the shaft seal arm 430 and shaft seal body 420 make contact with the inner bore insert leg 480 and create multiple sealing interfaces. The shaft seal arm 430 may also extend and contact the radial lip seal body 334.

The shaft seal arm 430 may have a cross-section shaped as a trapezoid where the side facing the aft direction 60 is longer than the side facing the forward direction 40. The shaft seal arm 430 may be shaped as a trapezoid revolved about the central axis 95. The shaft seal arm 430 can have a cross-section shaped as a triangle. The shaft seal arm 430 may have as a cross section shaped as a rectangle with a radiused end. The shaft seal arm 430 may be shaped as a quarter of a hollow cylinder revolved about the central axis 95.

The bore insert 450 can be disposed radially outward from the shaft seal 410. The bore insert 450 may be shaped as a stepped hollow cylinder. The bore insert 450 can be made of metal, plastic, composite material, or materials of the like. The bore insert 450 can be made from materials that are resistant to wear, produce low amounts of friction, and provide an adequate seal when used in contact with the shaft seal 410.

The bore insert 450 may include a bore insert aft end 455, the outer bore insert leg 460, a middle bore insert leg 470, the inner bore insert leg 480, and a bore insert forward end 485. The bore insert aft end 455 is disposed at the end of the bore insert 450 towards the aft direction 60. The outer bore insert leg 460 extends from the bore insert aft end 455 towards the forward direction 40. The outer bore insert leg 460 can extend from the bore insert aft end 455 towards the shaft seal 410. The outer bore insert leg 460 can be disposed between the housing 500 and the oil sealing assembly 300 and can be shaped as a hollow cylinder disposed around the oil sealing assembly 300. The outer bore insert leg 460 may be disposed within the bore space S1. The outer bore insert leg 460 may be in contact with the bore seal 350 and the housing 500. The outer bore insert leg 460 may vary in thickness, to accommodate the bore space S1. The middle bore insert leg 470 can extend radially inward from the outer bore insert leg 460 and may be shaped as an annulus around the shaft 200. The middle bore insert leg 470 may be shaped as a rectangular cross section revolved around the central axis 95. The middle bore insert leg 470 can extend radially outward from the outer bore insert leg 460 and may be shaped as an annulus around the shaft 200. The middle bore insert leg 470 can extend perpendicular from the outer bore insert leg 460. The middle bore insert leg 470 can extend axially towards the forward direction 40 and be shaped as a hollow cylinder around the shaft 200. The middle bore insert leg 470 may extend between the outer bore insert leg 460 and the inner bore insert leg 480 at 90 degrees with regard to the central axis or at a lesser or greater angle. The middle bore insert leg 470 may be in contact with the radial lip seal body 334. The middle bore insert leg 470 may be in contact with the housing 500. The inner bore insert leg 480 can extend from the middle bore insert leg 470 towards the forward direction 40 to the bore insert forward end 485 and may be shaped as a hollow cylinder around the shaft 200 and the shaft seal 410. The inner bore insert leg 480 can be in contact with the shaft seal arm 430. The inner bore insert leg 480 can be in contact with the shaft seal body 420. The inner bore insert leg 480 may extend in the forward direction 40 beyond where the shaft seal arm 430 contacts the inner bore insert leg 480. The inner bore insert leg 480 may extend perpendicular from the middle bore insert leg 470. The inner bore insert leg 480 may extend in the forward direction 40 beyond the shaft seal body 420. The inner bore insert leg 480 is operable to create a seal that prevents debris and contamination from entering the rotating shaft assembly by contacting the shaft seal arm 430. The thickness of the upper bore insert leg 460, the middle bore insert leg 470, and the inner bore insert leg 480, may vary in size with respect to each other. The bore insert forward end 485 is disposed distal from the bore insert aft end 455.

### INDUSTRIAL APPLICABILITY

The present disclosure generally applies to rotating shaft assemblies 100 for machinery, equipment, and transmissions or other mechanisms having an interface between rotating and non-rotating components. The disclosed shaft seal assembly 400 can help to limit harmful debris and contaminants from entering internal components of machinery, equipment, and transmissions, such as the oil sealing assembly 300. The described embodiments are not limited to use in conjunction with a particular type of machinery, equipment, or transmission as shaft seal assemblies 400, and thus their components, may be suited for any number of industrial applications.

Generally, embodiments of the presently disclosed shaft seal assembly 400 are applicable to the use, assembly, manufacture, operation, maintenance, repair, and improvement of rotating shaft assemblies 100, and may be used in order to improve performance and efficiency, decrease maintenance and repair, and/or lower costs. In addition, the shaft seal assembly 400 may be used in a first product, as a retrofit or enhancement to existing rotating shaft assemblies 100, as a preventative measure, or even in response to an event.

Functionally, the shaft 200 rotates along central axis 95. The oil sealing assembly 300 is non-rotatable and provides and contains lubricating oil for the shaft outer surface 225 as the shaft 200 rotates. The upper bore insert is operable to adapt the housing 500 to the oil sealing assembly 300 by filling the bore space S1. In particular, the outer bore insert leg 460 can allow shafts 200 of the same size to use standardized shaft seal 410 sizes and to be accommodated into varying sizes of bore spaces S1. The upper bore insert leg 460 can be operable to remain affixed between the housing 500 and the oil sealing assembly 300 during operation of the rotating shaft assembly 100 by use of friction and compressive force. Furthermore, the outer bore insert leg 460 can be press fit in the bore space S1. The middle bore insert leg 470 can be operable to provide a radial offset of the bore insert 450 from the upper bore insert leg 460 an can extend to the top of the shaft seal arm height H1 or match the shaft seal arm height H1. The inner bore insert leg 480 can be operable to create a seal that prevents debris and contamination from entering the rotating shaft assembly by contacting the shaft seal arm 430. The shaft seal body 420 is operable to remain affixed to the shaft 200 during operation of the rotating shaft assembly 100 by use of friction and contractive force. When the shaft 200 rotates shaft seal arm 430 is configured to remain in contact with inner bore insert leg 480 and maintain a seal that prevents debris and contaminants from entering the oil sealing assembly 300. In particular, the shaft seal arm 430 disclosed provides an axial seal with the inner bore insert leg 480, which can provide a better performing seal than a radial seal between the shaft seal arm 430 and the radial lip seal body 334. In addition, the inner bore insert leg 480 can extend beyond the contact surface of the shaft seal arm 430 further covering the shaft seal 410 and can further help prevent debris and contamination from entering the oil sealing assembly 300.

Although this invention has been shown and described with respect to detailed embodiments thereof, it will be understood by those skilled in the art that various changes in form and detail thereof may be made without departing from the spirit and scope of the claimed invention. Accordingly, the preceding detailed description is merely exemplary in nature and is not intended to limit the invention or the application and uses of the invention. In particular, the described embodiments are not limited to use in conjunction with a particular type of rotating shaft assembly. For example, the described embodiments may be applied to machinery, equipment, transmissions, or any variant thereof. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

What is claimed is:

1. A shaft seal assembly for use in a rotating shaft assembly, the rotating shaft assembly having a central axis, a shaft that rotates about the central axis and has a shaft outer surface, a housing, an oil sealing assembly, and a bore space between the housing and the oil sealing assembly, the shaft seal assembly comprising:
a shaft seal that encircles the shaft and includes
a shaft seal body that contacts the shaft outer surface, and extends radially outward from the central axis, and
a shaft seal arm that extends from the shaft seal body outward from the central axis; and
a bore insert disposed outward from the shaft seal and encircles the shaft and includes
an upper bore insert leg that extends towards the shaft seal and is disposed in the bore space,
a middle bore insert leg that extends from the upper bore insert leg towards the central axis, and
an inner bore insert leg that extends from the middle bore insert leg, and is disposed radially outward from the shaft seal and contacts the shaft seal arm.

2. The shaft seal assembly of claim 1 wherein the shaft seal arm extends to a shaft seal arm height that is the radial distance between the shaft outer surface and a top of the shaft seal arm, the middle bore insert leg extends to the top of the shaft seal arm height.

3. The shaft seal assembly of claim 2, wherein the middle bore insert leg extends perpendicular from the upper bore inset leg.

4. The shaft seal assembly of claim 3, wherein the inner bore insert leg extends perpendicular from the middle bore insert leg.

5. The shaft seal assembly of claim 4, wherein the inner bore insert leg extends beyond the shaft seal arm.

6. The shaft seal assembly of claim 1, wherein the shaft seal arm extends more radially outward than the shaft seal body.

7. The shaft seal assembly of claim 1, wherein the bore insert is shaped as a stepped hollow cylinder.

8. A shaft seal assembly for use in a rotating shaft assembly, the shaft seal assembly comprising:
a shaft seal includes
a shaft seal body that is sized to be deployed around a shaft of the rotating shaft assembly and operable to remain affixed around the shaft during operation of the rotating shaft assembly by use of friction and contractive force, and
a shaft seal arm that extends outward from the shaft seal body; and
a bore insert includes
an upper bore insert leg that is operable to fill a bore space between a housing and an oil sealing assembly of the rotating shaft assembly,
a middle bore insert leg that extends from the upper bore insert leg, and provides a radial offset of the bore insert from the upper bore insert, and
an inner bore insert leg that extends from the middle bore insert leg, and creates a seal by contacting the shaft seal arm.

9. The shaft seal assembly of claim 8, wherein the upper bore insert is operable to remain affixed between the housing and the oil sealing assembly during operation of the rotating shaft assembly by use of friction.

10. The shaft seal assembly of claim 8, wherein the shaft seal is a V-ring.

11. The shaft seal assembly of claim 8, wherein the middle bore insert leg extends perpendicular from the outer bore insert leg.

12. The shaft seal assembly of claim 8, wherein the inner bore insert leg extends perpendicular from the middle bore insert leg.

13. The shaft seal assembly of claim 8, wherein the shaft seal arm is cantilevered from the shaft seal body.

14. The shaft seal assembly of claim 8, wherein the shaft seal is made from at least one of fluoroelastomers, nitrile rubber elastomers, synthetic resin material, and elastomeric material.

15. The shaft seal assembly of claim 8, wherein the bore insert is made from at least one of metal, plastic, and composite material.

16. A shaft seal assembly for use in a rotating shaft assembly, the rotating shaft assembly having a central axis, a shaft that rotates about the central axis and has a shaft outer surface, a housing, an oil sealing assembly, and a bore space between the housing and oil sealing assembly, the shaft seal assembly comprising:
a bore insert disposed radially outward from the shaft and partially in the bore space; and
a shaft seal that encircles the shaft, is disposed inward of the bore insert and includes
a shaft seal body that contacts the shaft outer surface and extends radially outward from the central axis, and
a shaft seal arm that extends from the shaft seal body outward from the central axis and contacts the bore insert.

17. The shaft seal assembly of claim 16, wherein the bore insert is operable to fill a bore space between a housing and an oil sealing assembly of the rotating shaft assembly.

18. The shaft seal assembly of claim 17, wherein the bore insert comprises:
an upper bore insert leg that extends towards the shaft seal and is disposed in the bore space,
a middle bore insert leg that extends from the upper bore insert leg towards the central axis,
an inner bore insert leg that extends from the middle bore insert leg towards the shaft seal, and is disposed radially outward from the shaft seal and contacts the shaft seal arm.

19. The shaft seal assembly of claim 18, wherein the middle bore insert leg provides a radial offset of the bore insert from the upper bore insert.

20. The shaft seal assembly of claim 16, wherein the shaft seal arm creates a seal where it contacts the bore insert.
